(19) United States
(12) Patent Application Publication
(10) Pub. No.: US 2019/0324868 A1
(43) Pub. Date: Oct. 24, 2019

(54) BACKUP PORTION OF PERSISTENT MEMORY

(71) Applicant: HEWLETT PACKARD ENTERPRISE DEVELOPMENT LP, Houston, TX (US)

(72) Inventors: Suhas Shivanna, Bangalore (IN); Mahesh Babu Ramaiah, Bangalore (IN); Clarete Riana Crasta, Bangalore (IN); Viratkumar Maganlal Manvar, Bangalore (IN); Thomas L. Vaden, Fort Collins, CO (US); Andrew Brown, Houston, TX (US)

(21) Appl. No.: 15/957,552

(22) Filed: Apr. 19, 2018

(51) Int. Cl. G06F 11/14; G06F 11/16; G06F 13/28; G06F 12/02; G06F 3/06

(52) U.S. Cl. CPC G06F 11/1471; G06F 11/1662; G06F 11/1458; G06F 11/1451; G06F 3/0619; G06F 12/0246; G06F 3/0653; G06F 3/064; G06F 13/28

(57) ABSTRACT

Examples disclosed herein relate to backing up persistent memory. There is at least one memory addressable by at least one processor. The persistent memory includes a persistent memory region with multiple portions. A secondary storage includes a first backup of the persistent memory region. Modifications to the persistent memory region are tracked. Updated portions associated with the modifications are written to the secondary storage.

### BACKGROUND

Information Technology companies and manufacturers are challenged to deliver quality and value to consumers, for example by providing computing devices. These computing devices can include a volatile memory addressable by a processor, such as random access memory. Volatile memory would lose its data when power is removed. Persistent memory tends to be slower than addressable random access memory that is volatile. Some persistent memory can be implemented using a random access memory in conjunction with a backup power source.

### BRIEF DESCRIPTION OF THE DRAWINGS

The following detailed description references the drawings, wherein:

FIGS. 1 and 2 are a block diagrams of a computing systems capable of performing selective backup of persistent memory, according to an example;

FIG. 3 is a block diagram of a computing system capable of performing selective backup of persistent memory using a file system and/or nonvolatile memory driver, according to an example;

FIG. 4 is a block diagram of an example of a computing system capable of performing a selective backup of persistent memory to a secondary storage, according to an example;

FIG. 5 is a flowchart of a method for backing up a portion of persistent memory based on what portions of the persistent memory were modified compared to a backup of the persistent memory, according to an example; and

FIG. 6 is a block diagram of a computing device capable of performing a backup of a portion of persistent memory based on what portions of the persistent memory are modified compared to a backup, according to an example.

Throughout the drawings, identical reference numbers may designate similar, but not necessarily identical, elements. An index number “N” appended to some of the reference numerals may be understood to merely denote plurality and may not necessarily represent the same quantity for each reference numeral having such an index number “N”. Additionally, use herein of a reference numeral without an index number, where such reference numeral is referred to elsewhere with an index number, may be a general reference to the corresponding plural elements, collectively or individually. In another example, an index number of “I,” “M,” etc. can be used in place of index number N.

### DETAILED DESCRIPTION

Some persistent memory can provide the performance benefits closer to that of dynamic random access memory (DRAM), while providing the persistency of secondary storage such as solid state drives (SSDs), flash memory, hard disk drives, non-volatile memory express (NVMe) media, etc. Due to these benefits, many enterprises are adopting persistent memory solutions in datacenters with a complete software eco system to increase their workload performance and throughput. One example model morphs regular Dual In-line Memory Modules (DIMMs) into “Persistent Data Storage” by saving contents of DIMMs to secondary storage devices like SSDs/NVMe drives using backup power sources like an uninterruptable power supply (UPS) and restoring SSD/NVMe drive contents back to DIMMs on every power cycle event.

This approach holds some tradeoffs, such as a longer system shutdown time or reduced endurance of the backup drives and UPS due to the repetitive backup of the entire DIMM contents on each reboot. This could lead to increased replacements for failing parts.

As noted, DIMMs are “Volatile Data Storage” addressable by a processing element of a computing system and the data stored in the DIMMs are supposed to be the temporary data used by Application/OS which would be trashed at power loss. As noted, some persistent memory can use regular DIMMs as “Persistent Data Storage” using backup power source like a UPS and secondary storage devices like SSDs or NVMe drives (referred as secondary storage).

In various examples described herein, a space is carved out from regular DIMMs as a Persistent Memory region (referred as PMEM region) and provided to Operating System/Applications. Persistent Memory aware applications can use this space to achieve increased performance and higher throughput, as for these applications, the access time to Persistent Memory is same as regular DIMM latency which is relatively high in case of secondary storage compared to DIMMs. In one example, during planned or unplanned system downtime, user data stored in PMEM region gets backed into a secondary storage, with the aid of backup power and gets restored from secondary storage to PMEM region in subsequent system power on. Scenarios like system graceful power off, various types of Cold (Power Good) resets, Catastrophic reset, AC power loss etc. (referred as backup cases/scenarios in this paper) would trigger backup of PMEM region. Since the implementation uses regular DIMMs, it can provide large amounts of persistent memory compared to various other persistent memory solutions, since modern DIMMs are very dense and can provide terabytes of Persistent Memory space in a system.

The approaches described herein can also be used in other persistent memory configurations. For example, it can still be beneficial to keep a second copy of persistent memory (e.g., a persistent memory addressable by a processor of the computing system) in a secondary storage (e.g., a block storage).

However, the backup implementation can incur longer system downtime, reduced endurance of secondary storage and backup power supply. For example, planned or unplanned data center downtime can hurt the company in terms of costs. There can be a large per minute cost incurred during a downtime. The present implementation described backs the “entire” PMEM region and takes the same amount of time in every backup scenario, even when there is little or no modifications in PMEM region data. There may be an unnecessary backup of unmodified data, and this backup time can be significant especially for high volume configurations. This increased backup time increases the downtime (both planned and unplanned) of servers with persistent memory that backs up to secondary storage.

Wear out and the number of writes that occur on secondary storage are one of the factors in deducing the life span of various types of secondary storage. Some research shows that the disk storages may need to be replaced after 4 years and SSDs may show failures when close to 1 petabytes in writes occur. Backing of whole of PMEM region would lead to early replacement of secondary storage. The number of blocks to be erased and rewritten can be reduced compared to the entire PMEM region to be backed by selectively choosing which portions of the persistent memory region to backup. An advantage of the approach is providing better endurance from a wear out angle.

Similarly, advantages exist in less power usage from the UPS. During a backup scenario, the charge required by backup power supply is dependent on how much memory is backed up. Thus, when there is less memory to be backed up, there is less usage of the UPS, which can result in proportional gain with endurance of the UPS. For a manufacturer, the challenges described could lead to more wear and tear and frequent hardware replacements, adding to warranty cost and slightly increased planned and unplanned downtime.

Accordingly, approaches described herein show examples of performing selective data backup of persistent memory contents using intelligent approaches that track modifications in the non-volatile DIMMs (NVDIMMs) efficiently, thereby helping reduce backup time and hardware wear out. Example approaches can be based in hardware, software, or a combination thereof. The approaches can be distributed across the Operating System (OS), memory controller hardware, and system firmware (e.g., a basic input output system (BIOS)). The proposed solutions can provide increased availability, reliability, reduced cost, and an improved user experience by reducing backup time and wear out of secondary storage and UPS and improving availability of the computing systems using these approaches.

In one example, a software solution defines a capability of BIOS/Platform to perform a “Selective Backup” of PMEM region data which would be advertised to Operating System using appropriate Advanced Configuration and Power Interface (ACPI) tables. If the platform is capable of performing Selective Backup, the Operating System would then keep track of modified Page Frame Numbers (PFNs) throughout the server uptime and would provide this information to platform firmware (referred in various examples throughout as BIOS) to perform Selective Backup. As used herein, a page is a fixed-length contiguous block of virtual memory described by a single entry in a page table. It is a smallest unit of data for memory management in a virtual memory operating system. In the example, a page frame is the smallest fixed-length contiguous block of physical memory into which memory pages are mapped by the operating system. PFNs are used to track the page frames.

In one example, there are two phases. During phase 1, the PFNs would be tracked at a NVDIMM Driver or a PMEM Aware File System (e.g. Direct Access (DAX) File System) level. As noted above, there can be a region of memory that can be persistent and a region of memory that is not persistent. Thus, two sections would be carved out from regular memory which are referred as Section A and Section B. The details about base address and size of these sections would be communicated to Operating System using an appropriate ACPI table. Section A and Section B can be implemented in a volatile region of the memory or a non-volatile region of the memory.

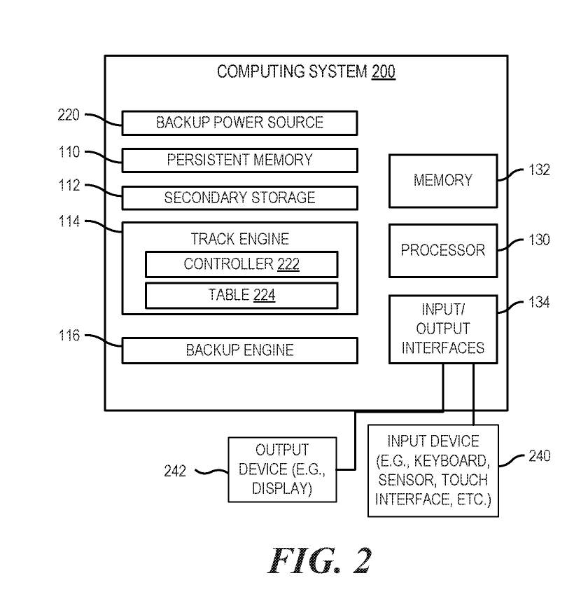

Any read/writes to the NVDIMM can go through the described NVDIMM Drivers or through the PMEM Aware File System or directly through a mmap interfaces provided by PMEM. In one example, when a file is opened on a /dev/pmem device for write operation (PMEM Aware File System access) the filename with the range of PFNs it is mapped to is noted in Section A of the shared memory region by the File System. On the file close operation, the PFNs modified in this file are noted down in Section B by the File System, and then the corresponding entry is deleted from Section A as shown in FIG. 3. This ensures synchronized capture of the modified PFNs to address each of the windows that exists between a page being modified and it being marked for backup.

Similarly if the /dev/pmem device is used for block access, during block write operation, corresponding modified PFNs are tracked by the NVDIMM Driver and noted down in the Section B as shown in the left side of FIG. 3, before the page being modified. Examples described herein covers the different access modes, raw block access, legacy filesystem, DAX FS access as well as direct load/store access.

Phase 2 revolves around the backup scenario. In the case of a backup scenario, the system would reset and platform firmware (e.g., BIOS) would take control of the system. Instead of backing up the entire PMEM region, platform firmware would take backup of the PFNs which have an entry in either Section A or B, captured by the OS. BIOS would map a given PFN in PMEM region to a block in secondary storage, erase that block and rewrite it with the modified data from the PMEM region. Once each of the PFNs present in Section A or B are backed up in secondary storage, the backup operation is considered as complete and backup power supply would be turned off. In the subsequent system power on, platform firmware can restore the entire PMEM region data from secondary storage to main memory (e.g., in the PMEM region).

Considering a fresh new system having scalable memory functionality enabled, there won't be any previous backup image of PMEM region saved in the secondary storage. Platform firmware would detect this case as “no backup image” case and platform firmware would take a complete backup of PMEM region in to secondary storage. This can serve as a base version of the backup.

In another example, a fast selective backup approach is provided that is hardware assisted. In this approach, a memory controller or the media controller for hardware devices that manages the persistent memory is used to atomically track the write/read on a memory region. In one example, the NVM controller could contain a table that maps to all the possible blocks/pages presented from the device. This enhanced NVM can maintain this bit table to represent each of the pages of the memory starting from the reboot to the power down and the size of the page can be made configurable to accommodate each possible block size. Logic can be implemented in the memory controller where on every write, the memory controller checks the address against a MASK value to determine if a specific page is being written and then the memory controller would set the corresponding bit in the bit table to mark this page dirty.

In some examples, the same logic could be configured for different PAGE sizes by providing a different MASK. The limit on the granularity that can be achieved is only constrained by the size of the provided MASK field and the size of the DIRTY bit-table. The MASK size can be implemented as a sufficient size to cover the entire address space of the memory-controller (32 or 64 bits). This data will be used by consumers like platform firmware or Direct Memory Access (DMA) controller to achieve the backup of only the modified pages of PMEM regions. In case of platform firmware, the dirty bit map can be consumed on the next backup phase, which can be implemented on a trigger (e.g., during next boot or during a shutdown phase) to backup the marked pages to secondary storage.

An illustration of the above example is shown below:

If the functionality is desired for 256 bytes and the memory is divided in 4 equal pages, then each page will be 64 bytes, and the MASK for the ‘address’ (lines) would be 11000000.

The memory controller logic implements something similar to;

If WRITE

PAGE=ADDRESS & MY_MASK 11000000

Right shift PAGE to normalize >>(6 bits)

PAGE is 0,1,2,3 —Mark PAGE as dirty in BIT table=DIRTY[PAGE]=TRUE

END

DIRTY now contains the list of MEMORY pages that are dirty that need to be backed up into secondary storage. The same logic could be configured for different PAGE sizes, by providing a different MASK.

In case of DMA support in the memory/NVM modules, like in a memory centric protocol such as the Gen-Z architecture with integrated media controllers, examples herein propose that these memory modifications on a volatile memory be tracked by an inherent media/memory controller present on the memory module. The modified information can be DMAed to the destination secondary storage using the memory centric protocol.

In various examples, larger volumes of persistency and higher backup speeds can be achieved through grouping the PFNs and attaching a dedicated target secondary storage/region for each group. In another example, the entire process of backing the modified PFNs across secondary storage devices can be distributed dynamically.

Even though this solution is focused on scalable persistent memory with battery backup, the concepts in this disclosure can be extended to any NVDIMM type for replication of the contents present in persistent memory for reliability, redundancy, and/or high availability. Persistent memory, whether it is Scalable Persistent Memory or NVDIMM-N or 3D XPoint DIMMS, present with a node, is a single point of failure, where all the data contained within the memory module is lost in case of a module/node failure. Many workloads adapting to these NVDIMMs require the NVDIMM content to be redundant, and to be highly available even in the case of failure of the node or the memory module. The approaches described herein to backup the NVDIMM content will reduce backup times for the redundant copy of NVDIMM.

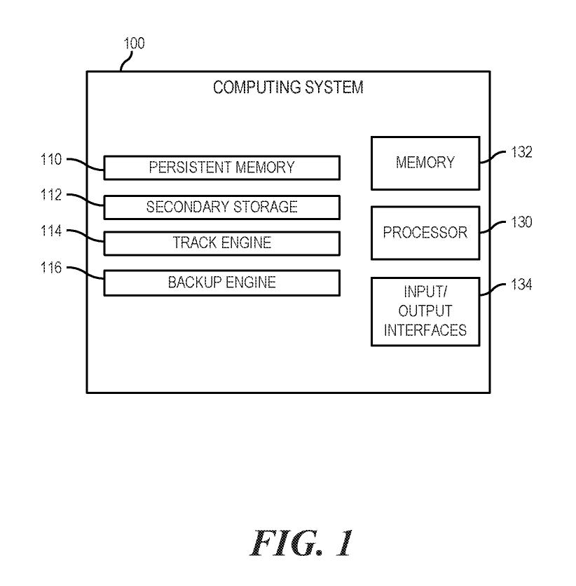

FIGS. 1 and 2 are a block diagrams of a computing systems capable of performing selective backup of persistent memory, according to an example. Computing system 100 can include a persistent memory 110, a secondary storage 112, a track engine 114, and a backup engine 116. The computing system 100 can further include at least one processor 130, memory 132, and input/output interfaces 134. Computing system 200 can further include a backup power source 220. In some examples, the backup power source 220 is an independent power source, such as a battery or supercapacitor. As noted, the persistent memory 110 can be implemented using a volatile memory in conjunction with the backup power source 220. In one example, the track engine of computing system 200 can include a controller 222 and a table 224. As noted above, in other examples, the track engine 114 can be implemented using a PMEM aware file system and/or NVDIMM drivers.

As noted above, the computing system 100, 200 can include at least one processor 130. The processor 130 can be, for example, one or multiple central processing units, or other processing elements that can address memory 132 such as persistent memory 110.

Persistent memory 110 can be implemented as a region of a main memory, for example, memory 132 of the computing system 200. The persistent memory region can be split into multiple portions. Examples of portions may include, for example, page frames. As noted, the persistent memory can be backed up to secondary storage 112. In some examples, the secondary storage can include a first version of a backup of the persistent memory region. This can occur as the first time a full backup is made of the persistent memory region and can be updated. As described herein, the first version means an existing version of a previous backup to the secondary storage 112. As discussed above, in some examples, the persistent memory 110 can be implemented using DIMMs in conjunction with a backup power source 220 and backup to secondary storage 112. In other examples, other varieties of persistent memory can be used.

As noted above, platform firmware can be used in conjunction with an operating system to backup the persistent memory 110 to the secondary storage 112. The platform firmware, through ACPI tables can inform an OS and/or applications to be executed on the computing system 200 that the persistent memory 110 is present and configuration/characteristics (e.g., location, speed, etc.) of the persistent memory 110. How this information is presented can be organized and harmonized between the OS/application and platform firmware.

The track engine 114 can be used to track modifications to the respective portions of the persistent memory 110. In the example of FIG. 3, the track engine 114 can be implemented using a PMEM-aware file system 310 and/or an NVDIMM Driver 312. FIG. 3 is a block diagram of a computing system capable of performing selective backup of persistent memory using a file system and/or nonvolatile memory driver.

In this example, the portions (e.g., page frames) are associated with page frame numbers and the PFNs are used to track the modifications. The PMEM-aware file system 310 or NVDIMM Driver 312 can be used to trap write access to PMEM PFNs 314, 316.

At the operating system or application level, when a file is opened 320, it can be associated with a file identifier. When the file is opened to be written to the persistent memory region, the track engine 114 can write the respective file identifier and an associated range of the PFNs in Section A 330. The changes to memory can continue in the NVDIMMs 350a-350n. When the file is closed 322, the PFNs that are modified during a time that the respective file is open are written to Section B 340 by the track engine 114. The file identifier is then removed from Section A 330.

In another example, if a /dev/pmem device is used for block access, during block write operation, corresponding modified PFNs are tracked by the NVDIMM Driver 312 and noted down in the Section B 340 as shown in the left side of FIG. 3, before the page being modified. Examples described herein cover various access modes, for example, raw block access, legacy filesystem, DAX File System access as well as direct load/store access.

In one example, an application can use a standard application programming interface (API) to access a file system to utilize the PMEM region. In another example, the file system can use a NVDIMM driver to access the PMEM region. In a further example, a management user interface (e.g., middleware) can utilize a management library to access the NVDIMM driver to utilize the PMEM region. In a further example, an application can use a PMEM aware file system such as DAX to access the PMEM region. In various examples, the PMEM aware file system can use a NVDIMM driver to access the PMEM region or may directly access the PMEM region. Various paths are contemplated for an application, OS, or middleware to access the PMEM region. Some paths can be block access, while others are file access or direct memory access. In some examples, the PMEM aware file system, a regular file system, a NVDIMM driver, etc. can be implemented in a kernel space while applications, management software, etc. are implemented in a user space.

During the backup operation, the backup engine 116 is to write the modifications of the portions that are associated with modifications to the secondary storage 112. The modifications can be the entire portion that is modified (e.g., the page frame associated with the page frame number that was modified). During backup, the PFNs tracked in Section A 330 and Section B 340 are identified as the portions that are associated with modifications.

The backup can occur in accordance with a trigger. In one example, the backup engine 116 is triggered periodically for a checkpoint. In another example, the trigger includes a graceful or ungraceful shutdown of the computing system 200. In one example, the trigger can be a restart of the computing system, the shutdown process, the boot process, etc. In the example of a boot process or during shutdown, the firmware can execute during the process on at least one processor 130. The process can retrieve the information from Section A 330 and Section B 340 and write the page frames from the NVDIMMS 350 identified in Section A 330 and Section B 340 to the secondary storage 112. As noted above, in one example, platform firmware executing on at least one processor 130 can be used to implement the backup engine 116 by receiving or retrieving the information in section A 330 and/or section B 340. Moreover, in some examples, a DMA approach may be used.

In another example, the track engine 114 can be implemented using additional hardware, for example a controller 222 and a table 224 associated with the controller 222. The controller 222 can be a memory or media controller. In some examples, one controller 222 can be used for multiple DIMMs. In other examples, each DIMM can be associated with a controller and/or table 224. The controller 222 can be used to manage a section of the persistent memory 110. The controller 222 can atomically track writes to the section. In some examples, a section can be considered a part of the persistent memory region. A section can include a DIMM or multiple DIMMs, or other partitions of the persistent memory 110. The section can include multiple portions (e.g., page frames). The controller 222 can maintain a table 224 of the portions associated with the section. When a write is performed on a portion, the portion is marked as dirty on the table as part of tracking modifications.

As noted above, in some examples, the controller 222 is located on a memory module. In this example, the memory module can include the section (e.g., the memory module or a portion of the memory module). Further, a direct memory access approach can be used to backup the modifications of the section to the secondary storage 112.

In this example, during backup, the backup engine 116 can receive or retrieve the table 224 from one or multiple track engines 114 or the controller 222. The table 224 can be used to determine what portions were modified (e.g., which portions were marked dirty). These portions can be written to the secondary storage 112. As noted above, the backup can be triggered via a trigger, occur during a boot process, occur during a shutdown process, etc. Writing of the dirty portions can constitute generating a second version of a backup. Additional versions of the backup can be created when the trigger occurs at a later time.

The table 224 can be implemented as a bit table to represent each of the portions (e.g., pages) of the memory starting from the reboot to the power down. The size of the portion can be made configurable to accommodate each possible block size. Logic can be implemented in the memory/media controller 222 where on every write, the memory/media controller 222 checks the address against a MASK value to determine if a specific portion is being written and then the controller 222 would set the corresponding bit in the bit table to mark this page dirty.

In some examples, the same logic could be configured for different PAGE sizes by providing a different MASK. The limit on the granularity that can be achieved is only constrained by the size of the provided MASK field and the size of the DIRTY bit-table. The MASK size can be implemented as a sufficient size to cover the entire address space of the memory/media controller 222 (e.g., 32 or 64 bits). This data can be used by consumers like platform firmware or Direct Memory Access (DMA) controller to achieve the backup of only the modified portions of PMEM regions. In case of platform firmware, the dirty bit map can be consumed on the next backup phase, which can be implemented on a trigger (e.g., during next boot or during a shutdown phase) to backup the marked pages to secondary storage. In some examples, in the case of a DMA controller another trigger may be used, such as a checkpoint to capture and backup the modified potions.

An illustration of an example is shown below. This is a simple example for illustrative purposes and it should be recognized that the approach can be extended as described herein.

If the functionality is desired for 256 bytes and the memory is divided in 4 equal pages, then each page will be 64 bytes, and the MASK for the ‘address’ (lines) would be 11000000.

The memory controller logic implements something similar to;

If WRITE

PAGE=ADDRESS & MY_MASK 11000000

Right shift PAGE to normalize >>(6 bits)

PAGE is 0,1,2,3 —Mark PAGE as dirty in BIT table=DIRTY[PAGE]=TRUE

END

DIRTY now contains the list of MEMORY pages that are dirty that need to be backed up into secondary storage. The same logic could be configured for different PAGE sizes, by providing a different MASK.

In case of DMA support in the memory/NVM modules, like in a memory centric protocol such as the Gen-Z architecture with integrated media controllers, examples herein propose that these memory modifications on a volatile memory be tracked by an inherent media/memory controller present on the memory module. The modified information can be DMAed to the destination secondary storage using the memory centric protocol.

In various examples, larger volumes of persistency and higher backup speeds can be achieved through grouping the PFNs and attaching a dedicated target secondary storage/region for each group. In another example, the entire process of backing the modified PFNs across secondary storage devices can be distributed dynamically.

In some examples, the secondary storage can include flash memory such as an NVMe drive or and SSD. These memories would not require contiguous space and portions can be updated without a large performance hit. Moreover, the secondary storage 112 can include a mapping of the persistent memory 110 to secondary storage 112. This way, on next boot, the persistent memory can be reloaded from the secondary storage 112. In some examples, the size of the portions is the same size or bigger than a block size used in the secondary storage 112. In other examples, portions can be marked as dirty and larger sized sections including the portions can be copied to the secondary storage 112. The larger sized sections can correlate to the size of a block in the secondary storage 112.

In some examples, the approaches described can occur locally within an NVDIMM-N. In this example, the backup power source 220 can be directly coupled to the NVDIMM. The NVDIMM can be within one range of the PMEM region of the persistent memory 110. The secondary storage 112 in this example can include a flash module local to the NVDIMM. Moreover, the track engine 114 can be implemented using a NVDIMM controller also local to the NVDIMM.

In this example, during the power on sequence, the NVDIMM can populate the memory from the local flash module. As described, the local track engine 114 can track changes on write. During a tigger event, such as a shutdown of the computer, a power off, a reboot, etc., the NVDIMM controller copies the contents of the modified regions tracked to the flash module rather than the contents of the entire memory module. Multiple such NVDIMMs can be used within the computing system 200. With this approach, in one example, only modified blocks (or other sized regions) are copied to the flash. A direct memory access approach can be used to transfer from the DIMMs to the associated local flash storage. Advantages include helping extend the flash module lifespan, the associated battery/supercapacitor backup, the time for backup, etc.

The engines 114, 116 include hardware and/or combinations of hardware and programming to perform functions provided herein. Moreover, the modules (not shown) can include programing functions and/or combinations of programming functions to be executed by hardware as provided herein. When discussing the engines and modules, it is noted that functionality attributed to an engine can also be attributed to the corresponding module and vice versa. Moreover, functionality attributed to a particular module and/or engine may also be implemented using another module and/or engine.

In some examples, backup engine 116 can be implemented using instructions executable by a processor and/or logic. In some examples, the backup engine can be implemented as platform firmware. Platform firmware may include an interface such as a basic input/output system (BIOS) or unified extensible firmware interface (UEFI) to allow it to be interfaced with. The platform firmware can be located at an address space where the processor 130 (e.g., CPU) for the computing system 100, 200 boots. In some examples, the platform firmware may be responsible for a power on self-test for the computing system 100, 200. In other examples, the platform firmware can be responsible for the boot process and what, if any, operating system to load onto the computing system 100, 200. In some examples, the platform firmware can take over during a shutdown process of the computing system 100, 200, for example, as part of a shutdown process where the OS turns over control of the computing system 100, 200 to the platform firmware. Further, the platform firmware may be capable to initialize various components of the computing system 100, 200 such as peripherals, memory devices, memory controller settings, storage controller settings, bus speeds, video card information, etc. As noted above, backup engine 116 may execute a process to backup modified PMEM region data into the secondary storage 112.

In one example, a memory semantic fabric can handle all communication as memory operations such as store/load, put/get, and atomic operations typically used by a processor. Memory semantics can be at a sub-microsecond latency from CPU load command to register store. An example of a memory semantic fabric implementation can include the Gen-Z framework. In one example, a memory controller that initiates high-level requests such as read, write, atomic put/get, etc. and enforces ordering, reliability, path selection, etc. can work with a media controller for implementation. The media controller can abstract memory media, support volatile, non-volatile, and mixed-media, perform media-specific operations, execute requests and return responses, enable data-centric computing (e.g., accelerator, computing, etc.), and the like. As such controller 222 can be implemented as one or multiple controllers working in conjunction with each other.

The Operating System is a system software that manages computer hardware and software resources and provides common services for computer programs. The OS can be executable on processing element and loaded to memory devices. The OS is a high level OS such as LINUX, WINDOWS, UNIX, a bare metal hypervisor, or other similar high level software that platform firmware of the computing system 100, 200 turns control of the computing system 100, 200 over to.

A processor 130, such as a central processing unit (CPU) or a microprocessor suitable for retrieval and execution of instructions and/or electronic circuits can be configured to perform the functionality of various functionality described herein. In certain scenarios, instructions and/or other information, such as modification information, can be included in memory 132 or other memory such as table 224. Input/output interfaces 134 may additionally be provided by the computing system 100, 200. For example, input devices 240, such as a keyboard, a sensor, a touch interface, a mouse, a microphone, virtual keyboard, video, mouse, etc. can be utilized to receive input from an environment surrounding the computing system 200. Further, an output device 242, such as a display, can be utilized to present information to users. Examples of output devices include speakers, display devices, amplifiers, etc. Moreover, in certain examples, some components can be utilized to implement functionality of other components described herein. Input/output devices such as communication devices like network communication devices or wireless devices can also be considered devices capable of using the input/output interfaces 134.

A communication network can use wired communications, wireless communications, or combinations thereof. Further, the communication network can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network can be in the form of a direct network link between devices. Various communications structures and infrastructure can be utilized to implement the communication network(s). One or more communication networks can couple the computing system 100, 200 to other computing systems. In other examples, a network can be used to communicate information stored in memory, for example via a fabric.

By way of example, systems and devices can communicate with each other and other components with access to the communication network via a communication protocol or multiple protocols. A protocol can be a set of rules that defines how nodes of the communication network interact with other nodes. Further, communications between network nodes can be implemented by exchanging discrete packets of data or sending messages. Packets can include header information associated with a protocol (e.g., information on the location of the network node(s) to contact) as well as payload information.

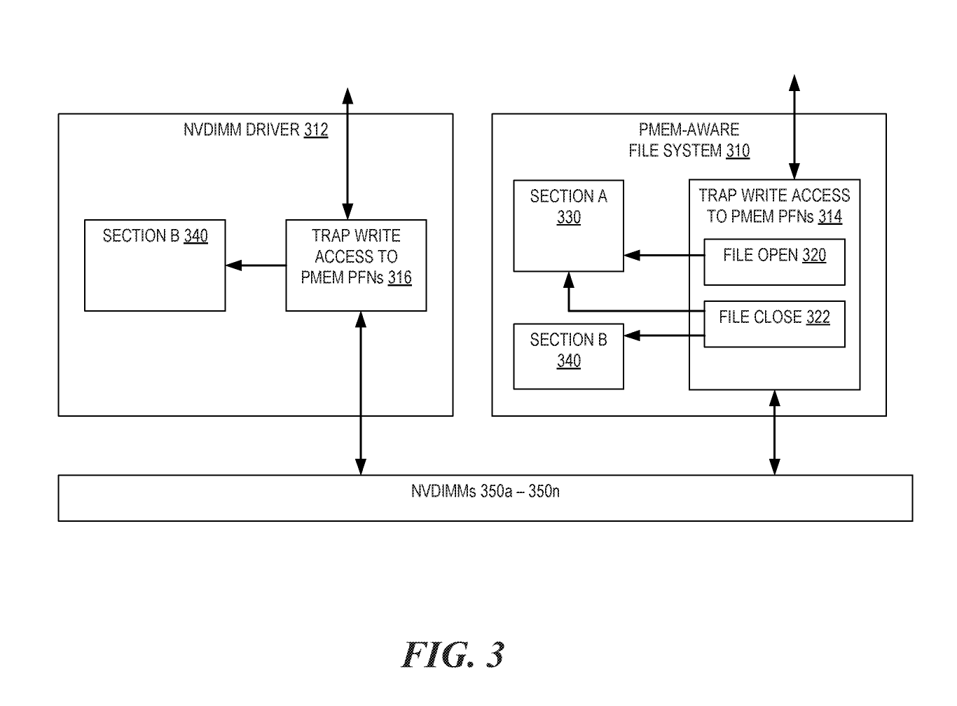

FIG. 4 is a block diagram of an example of a computing system capable of performing a selective backup of persistent memory to a secondary storage, according to one example. The diagram shows that multiple processors 430a, 430b-430m can use memory 432a-432n. A region of the memory 432 can include the persistent memory region. In the example of FIG. 4, the persistent memory region can be controlled by one or multiple controllers that can use a DMA to secondary storage such as an NVMe drive, an SSD, a HDD, etc. As noted previously, changes to the memory in the persistent memory region can be tracked via the tracking engine and backed up in response to a trigger. In some examples, different storage (here there are examples of various types of secondary storage, however a same type may be used) can be used to back up different parts of the persistent memory regions, for example, to utilize bandwidth that may be available.

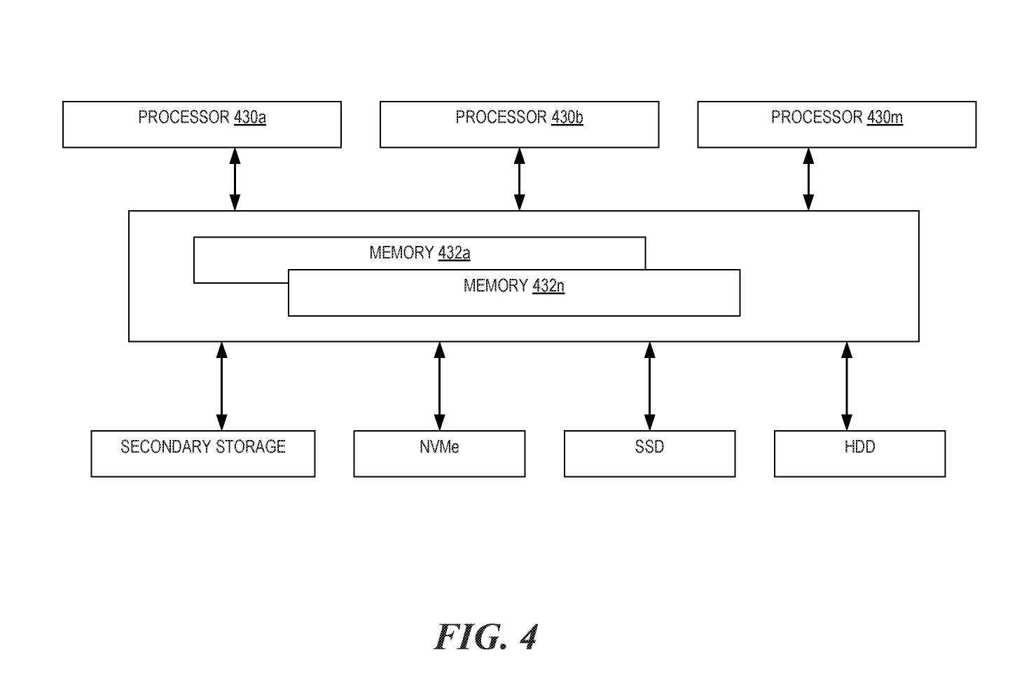

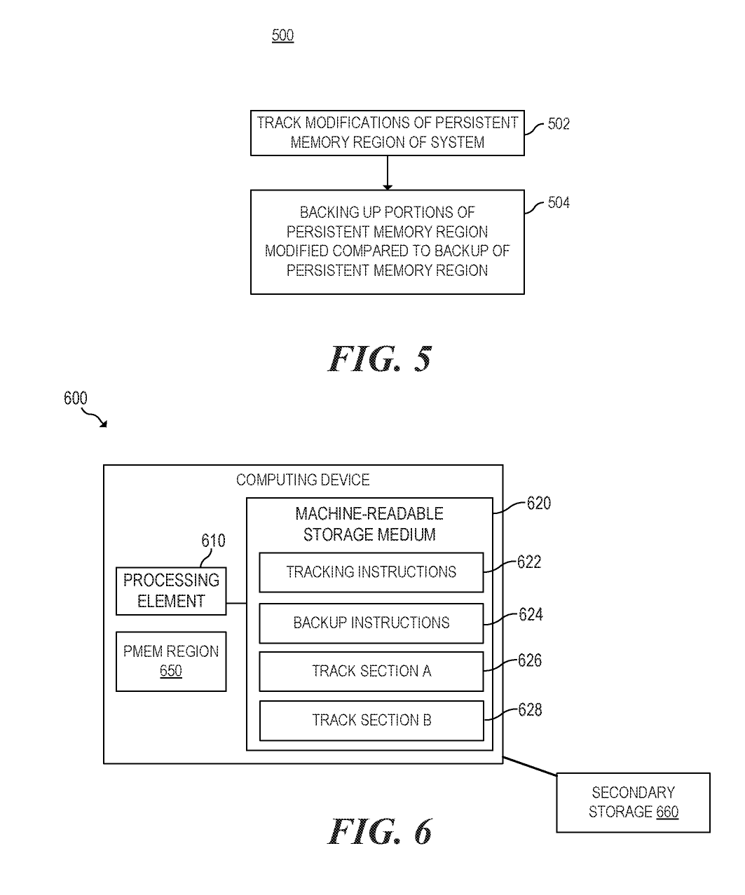

FIG. 5 is a flowchart of a method for backing up a portion of persistent memory based on what portions of the persistent memory were modified compared to a backup of the persistent memory, according to an example. FIG. 6 is a block diagram of a computing device capable of performing a backup of a portion of persistent memory based on what portions of the persistent memory are modified compared to a backup, according to an example.

Although execution of method 500 is described below with reference to computing device 600, other suitable components for execution of method 500 can be utilized (e.g., computing system 100, 200). Additionally, the components for executing the method 500 may be spread among multiple devices. Method 500 may be implemented in the form of executable instructions stored on a machine-readable storage medium, such as storage medium 620, and/or in the form of electronic circuitry. Though one machine-readable storage medium 620 is shown for example purposes, multiple machine-readable storage media can be used for implementation of method 500. For example, tracking instructions 622 may be stored on one medium and be associated with a higher level operating system, while the backup instructions 624 can be associated with a platform firmware and stored on a different medium (e.g., a read only memory (ROM)).

Processing element 610 may be, one or multiple central processing unit (CPU), one or multiple semiconductor-based microprocessor, one or multiple graphics processing unit (GPU), other hardware devices suitable for retrieval and execution of instructions stored in machine-readable storage medium 620, or combinations thereof. The processing element 610 can be a physical device. Moreover, in one example, the processing element 610 may include multiple cores on a chip, include multiple cores across multiple chips, multiple cores across multiple devices (e.g., if the computing device 600 includes multiple node devices), or combinations thereof. Processing element 610 may fetch, decode, and execute instructions 622, 624 to implement method 500. As an alternative or in addition to retrieving and executing instructions, processing element 610 may include at least one integrated circuit (IC), other control logic, other electronic circuits, or combinations thereof that include a number of electronic components for performing the functionality of instructions 622, 624.

Machine-readable storage medium 620 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 620 may be encoded with a series of executable instructions for selectively choosing memory to backup from a persistent memory region of memory addressable by the processing element 610.

Persistent memory can be implemented as a region of a main memory, for example, PMEM region 650 of the computing system 200. The persistent memory region can be split into multiple portions. Examples of portions may include, for example, page frames. As noted, the persistent memory can be backed up to secondary storage 660. In some examples, the secondary storage 660 can include a first version of a backup of the persistent memory region. This can occur as the first time a full backup is made of the persistent memory region and can be updated. As described herein, the first version means an existing version of a previous backup to the secondary storage 660. As discussed above, in some examples, the PMEM region 650 can be implemented using DIMMs in conjunction with a power source and backup to secondary storage 660. In other examples, other varieties of persistent memory can be used.

As noted above, platform firmware can be used in conjunction with an operating system to backup the PMEM region 650 to the secondary storage 660. The platform firmware, through ACPI tables, can inform an OS and/or applications to be executed on the computing device 600 that the PMEM region 650 is present and configuration/characteristics (e.g., location, speed, etc.) of the persistent memory. How this information is presented can organized and harmonized between the OS/application and platform firmware. In some examples, the computing device 600 can be booted up and the PMEM region 650 can be populated from the first backup from the secondary storage 660.

At 502 tracking instructions 622 can be executed by the processing element 610 to track modifications to respective portions of the PMEM region 650 of memory of the computing device 600. As noted above, the processing element can be capable of addressing the PMEM region 650. In some examples, the portions are associated with page frame numbers to track the modifications. The page frame numbers can correlate to particular page frames associated with the memory.

The executing tracking instructions 622 can be used to track modifications to the respective portions of the PMEM region 650. As noted above, the tracking instructions 622 can be implemented as a PMEM-aware file system such as a DAX file system and/or a NVDIMM Driver. In this example, the portions (e.g., page frames) are associated with page frame numbers and the PFNs are used to track the modifications. The PMEM-aware file system or NVDIMM driver can be used to trap write access to PMEM PFNs.

At the operating system or application level, when each file is opened, it can be associated with a file identifier. When the file is opened to be written to the persistent memory region, the file system and/or driver can write the respective file identifier and an associated range of the PFNs in Track Section A 626. The changes to memory can continue in the PMEM region 650. When the file is closed, the PFNs that are modified during a time that the respective file is open are written to Track Section B 628 by the file system and/or driver. The file identifier is then removed from Track Section A 626.

In another example, if a /dev/pmem device is used for block access, during a block write operation, corresponding modified PFNs are tracked by the NVDIMM Driver and noted down in the Track Section B 628 before the page being modified. Examples described herein cover various access modes, for example, raw block access, legacy filesystem, DAX File System access as well as direct load/store access.

At 504, backup instructions 624 are executed by the processing element 610 to backup portions of the PMEM region 650 identified as modified to the secondary storage 660 to generate a second version of the backup of the PMEM region 650. In following iterations a third, fourth, etc. version can be made.

During the backup operation, platform firmware and/or a controller (e.g., a media or memory controller) can write the modifications of the portions that are associated with modifications to the secondary storage 660. The modifications can be the entire portion that is modified (e.g., the page frame associated with the page frame number that was modified). During backup, the PFNs tracked in Track Section A 626 and Track Section B 628 are identified as the portions that are associated with modifications. In some examples, a wider range may be covered as “modified” in Track Section A 626 than actually modified. In this example, the “modified” term is expanded to the whole section due to the file being open.

The backup can occur in accordance with a trigger. In one example, triggers can be periodic as part of a checkpoint (e.g., in the case of using a memory controller for DMA to the secondary storage). In another example, the trigger includes a graceful or ungraceful shutdown of the computing device 600. In one example, the trigger can be a restart of the computing device 600, the shutdown process, the boot process, etc. In the example of a boot process or during shutdown, the firmware can execute during the process on the processing element 610. The process can retrieve or receive the information from Track Section A 626 and Track Section B 628 and write the page frames from the PMEM region 650 identified in Track Section A 626 and Track Section B 628 to the secondary storage 660.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

What is claimed is:

1. A computing system comprising:
at least one processor;
at least one persistent memory addressable by the at least one processor, the at least one persistent memory including a persistent memory region with a plurality of portions;
a secondary storage including a first version of a backup of the persistent memory region;
a track engine to track modifications to the respective portions; and
a backup engine to write the modifications of the portions that are associated with modifications to the secondary storage.

2. The computing system of claim 1, wherein the portions are associated with page frame numbers and the page frame numbers are used to track the modifications.

3. The computing system of claim 2, wherein when each file with a respective file identifier is opened to be written to the persistent memory region, the track engine is to write the respective file identifier and an associated range of the page frame numbers in a first track section of the persistent memory region.

4. The computing system of claim 3, wherein when the respective file is closed, the page frame numbers that are modified during a time that the respective file is open are to be written in a second track section of the persistent memory region by the track engine and remove the respective file identifier in the first track section.

5. The computing system of claim 4, wherein during a backup operation, the page frame numbers tracked in the first track section or the second track section are identified as the portions that are associated with modifications.

6. The computing system of claim 1, wherein the track engine includes a file system or a driver and the backup engine includes a firmware to execute on the at least one processor according to a trigger.

7. The computing system of claim 1, further comprising:
the track engine including a controller to manage a section of the at least one persistent memory, the controller to:
atomically track writes to the section;
maintain a table of the portions associated with the section; and
when a write is performed on a portion, mark the portion as dirty on the table as part of tracking the modifications.

8. The computing system of claim 7, further comprising:
the backup engine, during a boot or shutdown process of the computing system, receiving the table from the controller determine the modifications during a backup phase.

9. The computing system of claim 8, wherein the controller is located on a memory module that includes the section and a direct memory access approach is to backup the modifications of the section to the secondary storage.

10. The computing system of claim 1, wherein the persistent memory includes a backup power and a volatile memory.

11. A method comprising:
tracking modifications to respective portions of a persistent memory region of a memory of a computing system that includes the memory, at least one processor capable of addressing the persistent memory region, and a secondary storage including a first version of a backup of the persistent memory region,
wherein the portions are associated with page frame numbers to track the modifications; and
backing up the portions of the persistent memory region identified as modified to the secondary storage to generate a second version of the backup of the persistent memory region.

12. The method of claim 11,
wherein when each file with a respective file identifier is opened to be written to the persistent memory region, writing the respective file identifier and an associated range of the page frame numbers in a first track section of the persistent memory region.

13. The method of claim 12,
wherein when the respective file is closed:
writing, in a second track section of the persistent memory region, the page frame numbers that are modified during a time that the respective file is open; and
removing the respective file identifier in the first track section.

14. The method of claim 13, wherein during a backup operation that the backing up is responsive to, the page frame numbers tracked in the first track section or the second track section are identified as the portions that are associated with modifications.

15. The method of claim 11, wherein the tracking of the modifications is implemented at non-volatile memory driver or a file system of an operating system and the backing up is implemented using firmware executing on the at least one processor.

16. A computing system comprising:
at least one processor;
at least one persistent memory addressable by the at least one processor, the at least one persistent memory including a persistent memory region with a plurality of portions, wherein the at least one persistent memory includes a volatile memory with an independent power source;
a secondary storage including a first version of a backup of the persistent memory region;
a track engine including a controller to:
maintain a table of the portions associated with the persistent memory region to track modifications to the respective portions; and
when a write is performed on one of the portions, mark the respective portion as dirty on the table; and
a backup engine to write the portions associated as dirty on the table to the secondary storage to generate a second version of the backup of the persistent memory region.

17. The computing system of claim 16, wherein, during a boot or shutdown process of the computing system, the backup engine is to receive the table from the controller to generate the second version during the boot or shutdown process.

18. The computing system of claim 16, wherein the controller is located on a memory module that includes the persistent memory region and a direct memory access approach is used to backup the modifications of the section to the secondary storage.

19. The computing system of claim 16, wherein, on each write, the controller checks an address to be written using a mask to determine a respective portion to mark as dirty on the table, wherein the portions are pages.

20. The computing system of claim 16, wherein the backup to the secondary storage is distributed to multiple secondary storage units based on sections of the memory.
